(19) United States
(12) Patent Application Publication
(10) Pub. No.: US 2006/0209123 A1
(43) Pub. Date: Sep. 21, 2006

(54) High density reinforced orifice plate

(75) Inventors: Richard W. Sexton, Bainbridge, OH (US); James E. Harrison JR., Dayton, OH (US); John W. Wolff, Fresno, CA (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/081,111

(22) Filed: Mar. 16, 2005

(51) Int. Cl. B41J 2/145; G03C 5/00; B29C 45/14; B41J 2/15

(52) U.S. Cl. 347/40; 430/321; 264/267

(57) ABSTRACT

A method for forming a high resolution reinforced polymer orifice plate with jet array for an ink jet begins by electroforming an array of cells onto a base forming a cell assembly. The base has a smooth reflective surface. The cell assembly is coated with a polymer forming a filled assembly. A photomask is applied to the filled assembly; the filled assembly is exposed to ultraviolet light; and the polymer is removed from the filled assembly forming a nozzle plate assembly. The nozzle plate assembly has nozzles respective to the array of cells electroformed onto the base. The nozzle plate assembly is heated and the base is removed from the nozzle plate assembly forming an orifice plate with a jet array. The orifice plate and the jet array are composed of the filled polymer forming a smooth surface.

### FIELD OF THE INVENTION

The present embodiments relate generally to a high density orifice plate for achieving high resolution ink jet printing. The present embodiments relate more specifically to an electroformed orifice plate usable in ink jet printheads.

### BACKGROUND OF THE INVENTION

Ink jet nozzles formed of metal are subject to corrosion by aggressive inks. Typical electroforming methods to create metal reinforced nozzles for jet arrays of ink jet printers preclude spacing of the nozzles closer than about 300 per inch. Polymer nozzles made by laser drilling or by punching are limited to very thin sheet material that have low structural strength, and accordingly, do not provide jet arrays which maintain a straight line every time.

Orifice plates created using the prior art have been very thin and thus have low stiffness and poor linearity. Previously, the problem was attempted to be overcome using silicon, which is a stiff material, and chemically etching the silicon to provide a nozzle array. This process is slow and requires expensive special equipment. Further, the resulting silicon structures are brittle and subject to breakage.

A need exists for high density, high resolution orifice plates.

### SUMMARY OF THE INVENTION

Embodied herein are methods for forming a high resolution reinforced polymer orifice plate with jet array for an ink jet. The methods begin by electroforming an array of cells onto a base forming a cell assembly. The base has a smooth reflective surface. The cell assembly is coated with a polymer forming a filled assembly. A photomask is applied to the filled assembly; the filled assembly is exposed to ultraviolet light; and the polymer is removed from the filled assembly forming a nozzle plate assembly. The nozzle plate assembly has nozzles respective to the array of cells electroformed onto the base. The nozzle plate assembly is heated and the base is removed from the nozzle plate assembly forming an orifice plate with a jet array. The electroformed cells are covered and filled with the polymer forming a smooth surface. The jet array is formed at selected cells.

The present embodiments are advantageous over known orifice plates because the array is more resistant to scratching, corrosion, and physical distortion.

### BRIEF DESCRIPTION OF THE DRAWINGS

In the detailed description of the preferred embodiments of the invention presented below, reference is made to the accompanying drawings, in which:

FIG. 1 depicts a typical hexagonal high density electroformed plate formed by an embodied method.

FIG. 2 depicts the cross sectional view of a free standing orifice plate formed by an alternative embodied method.

The present embodiments are detailed below with reference to the listed Figures.

### DETAILED DESCRIPTION OF THE INVENTION

The present description will be directed in particular to elements forming part of, or cooperating more directly with, apparatus in accordance with the present invention. It is to be understood that elements not specifically shown or described may take various forms well known to those skilled in the art.

The present embodiments relate to forming an ink jet orifice plate by making a screen-reinforced composite of a photo-imageable polymer and electroformed screen and, then, imaging an array of high resolution nozzles formed in the screen interstices to create the plate.

The embodied methods provide an orifice plate that is highly corrosion resistant and has a high density of nozzles.

The methods contemplate a batch process that provides a reduced cost to create high density arrays, especially in contrast to the methods taught in the prior art.

The embodied methods produce structurally stiff high resolution nozzle plates for ink jet printers. Orifice plates produced by this method have good stiffness and excellent linearity. The compact hexagonal cell structure of the present embodiments improves stiffness and linearity of the arrays. For example, high density plates with more than 600 nozzles per inch have been produced using the embodied methods.

Printheads for ink jet printers are progressing to higher resolution and smaller nozzle diameters. The plates created by the embodied methods provide a printhead with increased resolution and decreased ink drop size. The linear arrays produced by the methods herein are not staggered and allow for higher printing speeds and economy of space greater than staggered arrays. The embodied methods produce a high resolution reinforced polymer orifice plate with jet array for an ink jet head.

An embodiment of the method for forming a high resolution reinforced polymer orifice plate with jet array for an ink jet method begins by electroforming an array of cells onto a base forming a cell assembly. The base has a smooth reflective finish. Preferably, the base is a conductive plate, such as a metal plate or a metalized non-conductive plate. The conductive plate can comprise nickel, steel, or alloys of these metals. Other types of conductive metals can be used in the electroforming to create the mesh or backbone of the cell structure. A non-conductive plate can be used as well, if the plate is metalized.

The array of cells preferably comprises cells in the shape of hexagons. Other geometric shapes, such as circles, triangles, rectangles, and other polygons, can be used.

Electroforming the array of cells onto a base adds a layer with a thickness ranging from about 25 micrometers to about 100 micrometers. The density of the cells made by the electroforming ranges from about 600 cells per inch to about 700 cells per inch. The methods contemplate that cell densities greater than 700 cells per inch can be created. Additionally, the cells can be electroformed wherein all the cells touch each other, or wherein the cells are formed into groups and spaces exist between the cells. In still another embodiment, the cells can be electroformed to have individual cells where small groups of cells are omitted. In this embodiment, the cells can be replaced with solid metal or polymer.

In all cases, the cell assembly has a cell density on the base that is greater than the nozzle density of the jet array. Although nickel cells are the most preferred for the metal mesh, a combination of metals can be electroformed. A first metal can be electroformed forming an initial structure and a second metal can be deposited over the first for added structural features or in order to reduce cost of the manufacturing process.

After the cell assembly is formed through electroforming, the cell assembly is coated with a liquid photo-imageable polymer to fill the array of cells and create a smooth surface. The coated cell assembly is a filled assembly. Although various liquid photo-imageable polymers can be used, the preferred polymer is an epoxy, such as SU-8 available from Microchem of Newton, Mass. Other polymers usable in the embodied methods include polyimides and combinations of polyimides and epoxies.

A nozzle plate assembly is formed from the cell assembly by applying a photomask to the filled assembly, exposing the filled assembly with the photomask to ultraviolet light, and removing the polymer from the filled assembly to form the nozzle array. The applied photomask is aperture pattern typically on a glass substrate that is then imaged onto the photo-imageable polymer. Apertures are formed into the polymer to form nozzles. The ultraviolet light is used to cure the liquid photo-imageable polymer into a hardened substance. The polymer is typically removed from the filled assembly by dissolving, peeling, developing, vaporizing, or combinations thereof. If the polymer is dissolved, a solvent, such as acetone, aqueous sodium carbonate, cyclopentanone, or combinations thereof, is typically used. The suitable solvent should be selected after due consideration of the type of photo-imageable polymer applied to fill the cells. The solvent should not additionally dissolve or affect the polymerized polymer.

The formed nozzle plate assembly has nozzles that correspond to the cells in the array of cells electroformed onto the base.

The nozzle plate assembly is then heated, typically by baking the nozzle plate assembly at an elevated temperature.

The method ends by removing the base from the nozzle plate assembly, thereby forming an orifice plate with a jet array. The base can be removed by peeling, etching, thermal shock, or combinations thereof. The formed orifice plate is covered with a smooth polymer surface. The formed jet array is made of apertures within the polymer and has a smooth finish.

Alternatively, screens and plates produced by the embodied methods can be used for gratings used for the fine diffraction of light.

In an alternative embodiment, a liquid curable polymer is added to the array of cells electroformed onto the base. The curable polymer is then cured into a hardened surface. The liquid curable liquid is typically cured by heating the liquid to a temperature ranging from about 100 degrees F. to about 150 degrees F. The polymer is removed from the filled assembly using laser ablation to form the nozzles. More specifically, this embodiment forms a high resolution reinforced polymer orifice plate with a jet array for an ink jet head.

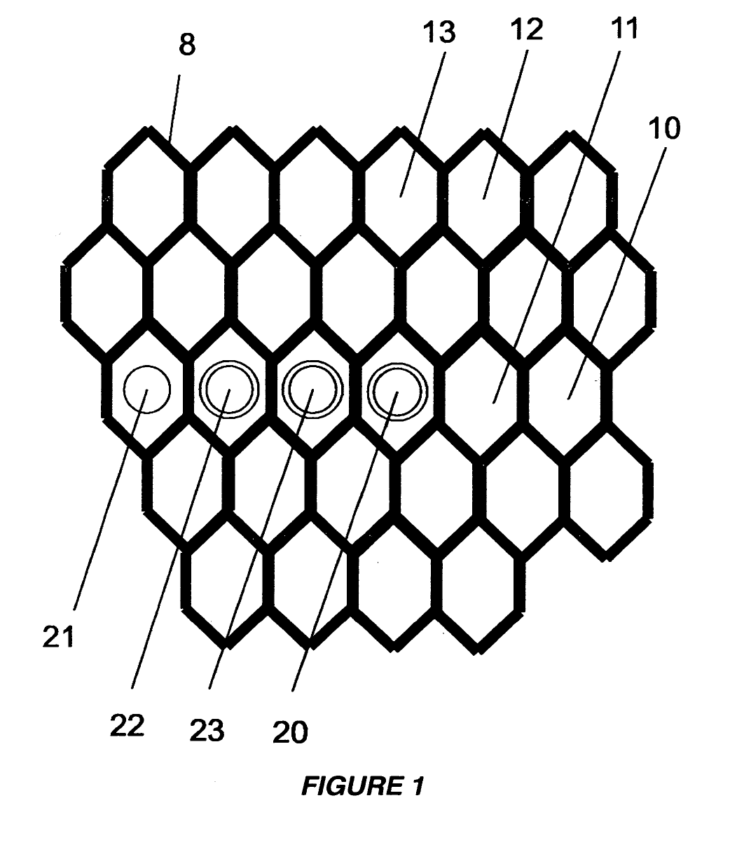

With reference to the figures, FIG. 1 depicts plan view of a typical hexagonal high density electroformed cell array on a copper substrate. The cell array is coated with one of several photo-imageable polymers. The top view in FIG. 1 shows the electroformed mesh 8 surrounding the filled cells 10, 11, 12, and 13. Nozzles 20, 21, 22, and 23 have been imaged and developed in the centers of the array of hexagonal cells. The cells 10, 11, 12, and 13 in FIG. 1 are depicted as hexagons because hexagons have a large open area and a strong structural shape. In the most preferred embodiment, the cells 10, 11, 12, and 13 are tightly fitted together in order to reinforce the structure.

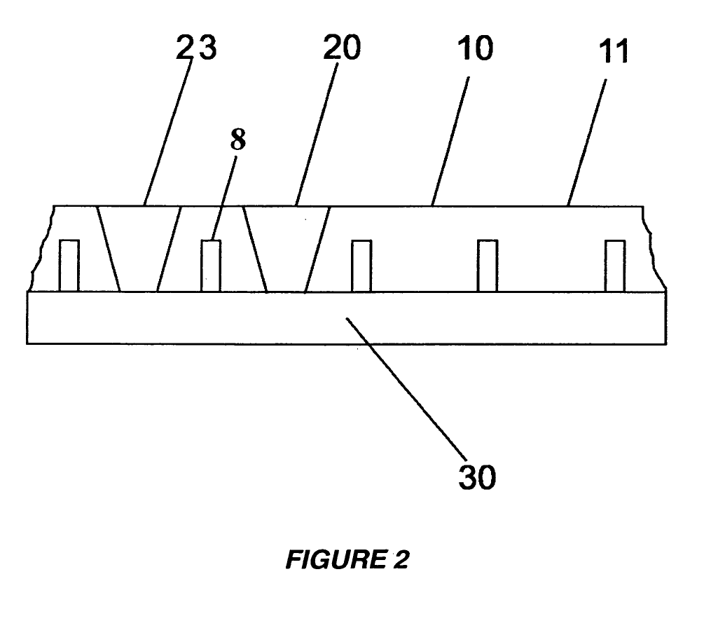

FIG. 2 depicts the cross sectional view of the structure shown in FIG. 1 while the structure is still attached to the base 30. The cross section of nozzles 20 and 23 are shown with reinforcing electroformed metal mesh 8 embedded in the photo-imageable polymers between the nozzles. FIG. 2 depicts filled cells 10 and 11, wherein the nozzles have not been fabricated. As shown, the photo-imageable polymer can be thicker than that of the electroformed mesh 8. The nozzles are shown with tapered walls. The nozzle wall can be non-tapered. The taper of the walls would be determined by the optics used in the step of photo-imaging the polymer.

The invention has been described in detail with particular reference to certain preferred embodiments thereof, but it will be understood that variations and modifications can be effected within the spirit and scope of the invention.

### Parts list

8. electroformed mesh

10. cell

11. cell

12. cell

13. cell

20. nozzle

21. nozzle

22. nozzle

23. nozzle

30. base

1. A method for forming a high resolution reinforced polymer orifice plate with jet array for an ink jet, wherein the method comprises the steps of:
a. electroforming an array of cells (10, 11, 12, and 13) onto a base (30) forming a cell assembly, wherein the base (30) comprises a smooth reflective surface;
b. coating the cell assembly with a liquid photo-imageable polymer forming a filled assembly, wherein the liquid photo-imageable polymer fills the array of cells (10, 11, 12, and 13);
c. applying a photomask to the filled assembly;
d. exposing the filled assembly with the photomask to ultraviolet light;
e. removing the polymer from the filled assembly forming a nozzle plate assembly, wherein the nozzle plate assembly comprises nozzles with respect to the array of cells (10, 11, 12, and 13);
f. heating the nozzle plate assembly; and
g. removing the base from the nozzle plate assembly forming an orifice plate with a jet array, wherein the orifice plate and the jet array are covered and filled with the polymer creating a smooth surface.

2. The method of claim 1, wherein the step of electroforming an array of cells onto a base adds the array of cells to the base at a thickness ranging from about 25 micrometers to about 100 micrometers.

3. The method of claim 1, wherein the step of electroforming an array of cells onto a base adds the array of cells to the base at a density of 700 cells per inch.

4. The method of claim 1, wherein the array of cells is an array of hexagonal cells.

5. The method of claim 1, wherein the base is a conductive plate.

6. The method of claim 5, wherein the conductive plate is a metal plate or a metalized non-conductive plate.

7. The method of claim 5, wherein the conductive plate is selected from the group consisting of nickel, steel, and alloys thereof.

8. The method of claim 1, wherein the liquid photo-imageable polymer is selected from the group consisting of an epoxy, a polyimide, and combinations thereof.

9. The method of claim 1, wherein the photomask is a thin film comprising a defined pattern of holes disposed on a glass substrate.

10. The method of claim 1, wherein the step of removing the polymer from the filled assembly is preformed by dissolving, peeling, developing, vaporizing or combinations thereof.

11. The method of claim 10, wherein the step of removing the polymer by dissolving utilizes a solvent is selected from the group consisting of acetone, aqueous sodium carbonate, cyclopentanone, and combinations thereof.

12. The method of claim 1, wherein the step of heating the nozzle plate assembly is performed by baking the nozzle plate assembly to an elevated temperature.

13. The method of claim 1, wherein the step of removing the base is performed by peeling, etching, thermal shocking, or combinations thereof.

14. The method of claim 1, wherein the orifice plate comprises a cell density that is greater than the nozzle density of the jet array.

15. An orifice plate for an ink jet printhead made by the method of claim 1.

16. A method for forming a high resolution reinforced polymer orifice plate with jet array for an ink jet head wherein the method comprises the steps of:
a. electroforming an array of cells onto a base forming a cell assembly, wherein the base comprises a smooth reflective surface;
b. coating the cell assembly with a liquid curable polymer forming a filled assembly, wherein the liquid curable polymer fills the array of cells;
c. heating the filled assembly thereby curing the filled assembly forming a cured filled assembly;
d. removing the polymer from the cured filled assembly by laser ablating, thereby forming a nozzle plate assembly, wherein the nozzle plate assembly comprises nozzles with respect to the array of cells; and
e. removing the base from the nozzle plate assembly forming an orifice plate with a jet array, wherein the orifice plate and the jet array are covered and filled with the polymer creating a smooth surface.

17. The method of claim 16, wherein the step of electroforming an array of cells onto a base adds the array of cells to the base at a thickness ranging from about 25 micrometers to about 100 micrometers.

18. The method of claim 16, wherein the step of electroforming an array of cells onto a base adds the array of cells to the base a density of 700 cells per inch.

19. The method of claim 16, wherein the base is a conductive plate.

20. The method of claim 19, wherein the conductive plate is a metal plate or a metalized non-conductive plate.

21. The method of claim 19, wherein the conductive plate is selected from the group consisting of nickel, steel, and alloys thereof.

22. The method of claim 16, wherein the liquid polymer is selected from the group consisting of an epoxy, a polyimide, and combinations thereof.

23. The method of claim 16, wherein the orifice plate comprises a cell density that is greater than the nozzle density of the jet array.

24. An orifice plate for an ink jet printhead made by the method of claim 16.
